(19) United States
(12) Patent Application Publication
(10) Pub. No.: US 2026/0252854 A1
(43) Pub. Date: Aug. 27, 2026

(54) CONVOLUTIONAL NEURAL NETWORK INFERENCE PROCESSING DEVICE, CONVOLUTIONAL NEURAL NETWORK INFERENCE PROCESSING METHOD, AND CONVOLUTIONAL NEURAL NETWORK INFERENCE PROCESSING PROGRAM

(71) Applicant: NIPPON TELEGRAPH AND TELEPHONE CORPORATION, Tokyo (JP)

(72) Inventors: Shuhei YOSHIDA, Tokyo (JP); Hiroyuki UZAWA, Tokyo (JP); Saki HATTA, Tokyo (JP); Yuko IINUMA, Tokyo (JP); Yuya OMORI, Tokyo (JP); Daisuke KOBAYASHI, Tokyo (JP); Ken NAKAMURA, Tokyo (JP)

(73) Assignee: NIPPON TELEGRAPH AND TELEPHONE CORPORATION, Tokyo (JP)

(21) Appl. No.: 18/992,075

(22) PCT Filed: Jul. 13, 2022
(86) PCT No.: PCT/JP2022/027590

§ 371 Date: Jan. 7, 2025

(51) Int. Cl. G06N 3/0464

(52) U.S. Cl. CPC G06N 3/0464

(57) ABSTRACT

A region extraction unit (32) extracts each region when an input image input to a convolutional neural network including a plurality of convolutional layers is divided into a region of a maximum size which is processable as the input image and a plurality of regions obtained by overlapping regions with an overlap amount corresponding to a reduction in the input image by the convolutional layers; a calculation unit (33) performs convolution calculation by the plurality of convolution layers that are integrated using data of the extracted region as input data; and an output unit (35) combines and output results of the calculation on the plurality of regions.

### TECHNICAL FIELD

The disclosed technique relates to a convolutional neural network inference processing device, a convolutional neural network inference processing method, and a convolutional neural network inference processing program.

### BACKGROUND ART

In recent years, image recognition, object recognition, and the like in which a convolutional neural network (CNN) is used have been applied for use cases in which real-time performance, power saving, and area saving of surveillance cameras, drones, and the like are obtained. Therefore, research and development of hardware used for CNN inference processing have been actively conducted. For example, when it is assumed that memory resources limited at edges are used, it is important to reduce a usage amount of external memory band. There is a technique called a layer integration scheme as a technique capable of reducing a usage amount of an external memory band.

### CITATION LIST

### Non Patent Literature

NPL 1 F. Indirli, A. Erdem and C. Silvano, “A Tile-based Fused-layer CNN Accelerator for FPGAs,” 2020 27th IEEE International Conference on Electronics, Circuits and Systems (ICECS), 2020, pp . . . 1 to 4, doi: 10.1109/ICECS49266.2020.9294981.

### SUMMARY OF INVENTION

### Technical Problem

Although a layer integration scheme which is one of the technique of the related art is useful in that the usage amount of an external memory band can be reduced, there is a problem that a size of an input image is limited in accordance with an internal memory capacity. Therefore, and therefore expansibility of the size of the input image is low.

The disclosed technique has been devised in view of the foregoing circumstances, and an object of the disclosed technique is to expand the size of an input image that can be processed in a layer integration scheme of a CNN without an increase in an internal memory capacity.

### Solution to Problem

According to a first aspect of the present disclosure, a convolutional neural network inference processing device, includes: a region extraction unit configured to extract each region in a case in which an input image input to a convolutional neural network including a plurality of convolutional layers is divided into a region of a maximum size, which is processable as the input image, and a plurality of regions obtained by overlapping regions with an overlap amount corresponding to a reduction in the input image by the convolutional layers; a calculation unit configured to perform convolution calculation by the plurality of convolution layers that are integrated using data of the region extracted by the region extraction unit as input data; and an output unit configured to combine and output results of the calculation performed by the calculation unit on each of the plurality of regions.

According to a second aspect of the present disclosure, a convolutional neural network inference processing method, includes: extracting, by a region extraction unit, each region in a case in which an input image input to a convolutional neural network including a plurality of convolutional layers is divided into a region of a maximum size, which is processable as the input image, and a plurality of regions obtained by overlapping regions with an overlap amount corresponding to a reduction in the input image by the convolutional layers; performing, by a calculation unit, convolution calculation by the plurality of convolution layers that are integrated using data of the region extracted by the region extraction unit as input data; and combining and outputting, by an output unit, results of the calculation performed by the calculation unit on each of the plurality of regions.

According to a third aspect of the present disclosure, a convolutional neural network inference processing program causes a computer to function as: a region extraction unit configured to extract each region in a case in which an input image input to a convolutional neural network including a plurality of convolutional layers is divided into a region of a maximum size, which is processable as the input image, and a plurality of regions obtained by overlapping regions with an overlap amount corresponding to a reduction in the input image by the convolutional layers; a calculation unit configured to perform convolution calculation by the plurality of convolution layers that are integrated using data of the region extracted by the region extraction unit as input data; and an output unit configured to combine and output results of the calculation performed by the calculation unit on each of the plurality of regions.

### Advantageous Effects of Invention

According to the disclosed technique, it is possible to expand a processable size of an input image size in a CNN layer integration scheme without an increase in an internal memory capacity.

### BRIEF DESCRIPTION OF DRAWINGS

FIG. 1 is a diagram illustrating tiles in a layer integration scheme of a CNN in the technique of the related art.

FIG. 2 is a block diagram illustrating a hardware configuration of a convolutional neural network inference processing device according to first and second embodiments.

FIG. 3 is a block diagram illustrating an example of a functional configuration of a convolutional neural network inference processing device according to the first embodiment.

FIG. 4 is a diagram illustrating an example of regions extracted from an input image.

FIG. 5 is a diagram illustrating processing of a calculation unit and an output unit.

FIG. 6 is a flowchart illustrating a flow of the convolutional neural network inference processing according to the first embodiment.

FIG. 7 is a block diagram illustrating an example of a functional configuration of the convolutional neural network inference processing device according to the second embodiment.

FIG. 8 is a diagram illustrating an example in which a region is divided into nine tiles.

FIG. 9 is a diagram illustrating processing of a generation unit, a calculation unit, and an overlap width extraction unit.

FIG. 10 is a flowchart illustrating a flow of convolutional neural network inference processing according to the second embodiment.

### DESCRIPTION OF EMBODIMENTS

Hereinafter, examples of embodiments of the disclosed technology will be described with reference to the drawings. In each drawing, the same or equivalent constituents and portions are denoted by the same reference numerals. Dimensional ratios in the drawings are exaggerated for convenience of description and may differ from actual ratios.

### <Limitation of Size of Input Image in Layer Integration Scheme of CNN>

Before the details of embodiments are described, the limitation of a size of an input image in the layer integration scheme of the technique of the related art will be described.

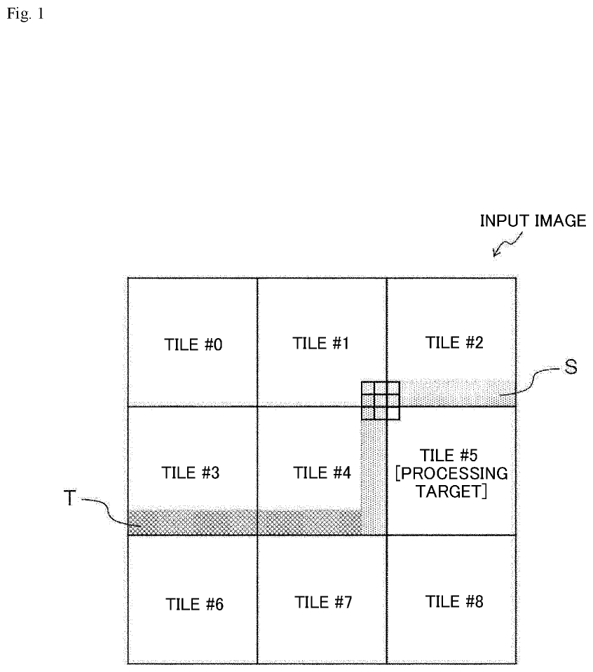

In the CNN layer integration scheme, processing in a plurality of layers is continuously performed in units of tiles obtained by dividing an input image into a grid form. In an example of FIG. 1, the input image is divided into nine tiles #0 to #8. For example, calculation processing of each tile is performed in order from left to right and from top to bottom, that is, in order of tiles #0 to #8 by using the tile positioned at the upper left of the input image as a base point.

Here, when convolution calculation of a boundary between the tiles is performed on each tile using a kernel of, for example, 3 pixels×3 pixels, data of a part of the tile adjacent to a processing target tile is used. This data is hereinafter referred to as “overlap width data”. It is necessary to retain the overlap width data in an internal memory during the convolution calculation of the boundary between the tiles. For example, as illustrated in FIG. 1, when tile #5 is a processing target tile, a portion S indicated by halftone dots is required as the overlap width data.

In the internal memory, not only overlap width data required for the convolution calculation of the processing target tile but also overlap width data required for the convolution calculation of a subsequent processing target tile are retained. For example, when tile #5 is a processing object, a portion T required during processing of subsequent tiles #6 and #7 is also retained as the overlap width data. For the overlap width data in the vertical direction, only the tiles immediately before the processing target tile may be retained. However, for the overlap width data in the horizontal direction, it is necessary to retain a maximum width of the input image.

However, there is restriction on an internal memory capacity. Therefore, an input image with a width of which an amount of overlap width data in the horizontal direction exceeding the internal memory capacity cannot retain required overlap width data, and the convolution calculation cannot be performed. That is, the input image is limited to a size which can be calculated with the overlap width data which can be retained in the internal memory.

In each of the following embodiments, the input image with a size equal to or larger than a maximum size that can be processed in the related art can be processed by overlapping regions with the maximum input size that can be processed in the related art as a region unit. Hereinafter, each embodiment will be described.

### First Embodiment

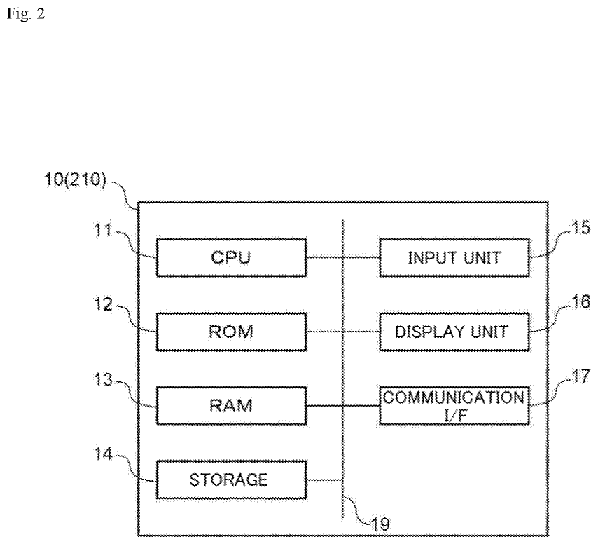

FIG. 2 is a block diagram illustrating a hardware configuration of a convolutional neural network inference processing device 10 according to a first embodiment.

As illustrated in FIG. 2, the convolutional neural network inference processing device 10 includes a central processing unit (CPU) 11, a read only memory (ROM) 12, a random access memory (RAM) 13, a storage 14, an input unit 15, a display unit 16, and a communication interface (I/F) 17. The constituents are connected to be able to communicate with each other via a bus 19.

The CPU 11 is a central processing unit and executes various programs or controls each unit. That is, the CPU 11 reads a program from the ROM 12 or the storage 14 and executes the program using the RAM 13 as a work area. The CPU 11 performs control of each configuration and various types of calculation processing according to programs stored in the ROM 12 or the storage 14. In the present embodiment, a convolutional neural network inference processing program performing convolutional neural network inference processing to be described below is stored in the ROM 12 or the storage 14.

Various programs and various types of data are stored in the ROM 12. A program or data is temporarily stored in the RAM 13 that serves as a work area. The storage 14 is configured with a storage device such as a hard disk drive (HDD) or a solid state drive (SSD), and stores various programs including an operating system, and various pieces of data.

The input unit 15 includes a pointing device such as a mouse or a keyboard and is used for various inputs. The display unit 16 is, for example, a liquid crystal display and displays various types of information. A touch panel scheme may be adopted for the display unit 16 which may function as the input unit 15.

The communication I/F 17 is an interface for communication with other devices. In the communication, for example, a wired communication standard such as Ethernet (registered trademark) or FDDI, or a wireless communication standard such as 4G, 5G, or Wi-Fi (registered trademark) is used.

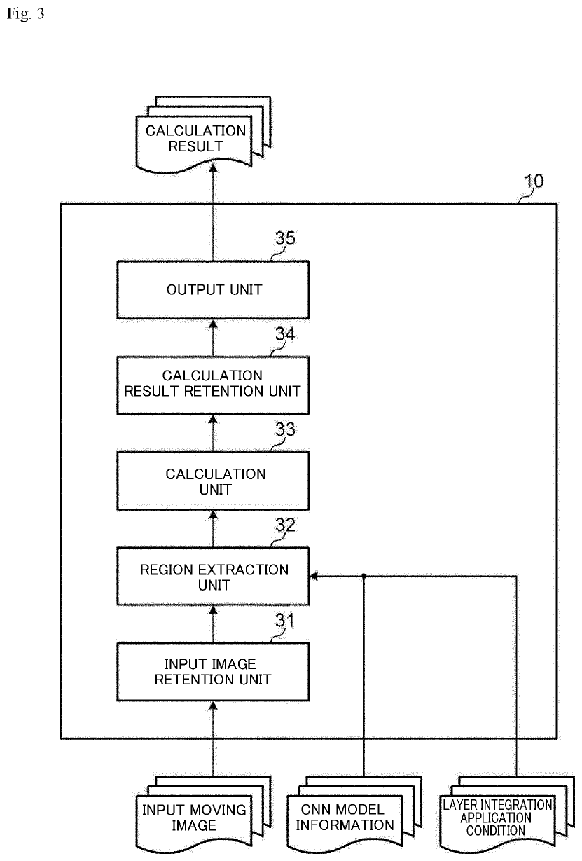

Next, a configuration of the convolutional neural network inference processing device 10 will be described. FIG. 3 is a block diagram showing an example of a functional configuration of the convolutional neural network inference processing device 10.

As illustrated in FIG. 3, the convolutional neural network inference processing device 10 includes, as functional constituents, an input image retention unit 31, a region extraction unit 32, a calculation unit 33, a calculation result retention unit 34, and an output unit 35. Each functional constituent is realized by the CPU 11 reading the convolutional neural network inference processing program stored in the ROM 12 or the storage 14, and loading and executing the convolutional neural network inference processing program on the RAM 13.

The input image retention unit 31 retains an input moving image input to the convolutional neural network inference processing device 10 in units of frames. Hereinafter, one frame of the input moving image is referred to as an “input image”. The input image retention unit 31 is provided in an external memory.

The region extraction unit 32 extracts each region in a case in which an input image input to a CNN including a plurality of convolution layers is divided into a region of a maximum size that can be processed as an input image in the related art and a plurality of regions in which the regions overlap by a predetermined overlap amount. The maximum size which is processable as an input image in the related art is a maximum size of the input image determined in accordance with an internal memory capacity when the present embodiment is not adopted.

It is necessary to determine the overlap amount in consideration of a reduction in the output size with respect to the input size by the convolution calculation. That is, the overlap amount is set to an amount corresponding to a reduction in the input image by a convolution layer. Specifically, the region extraction unit 32 acquires CNN model information including information such as the number of layers included in the CNN and a kernel size, and a layer integration application condition including information of layers to be integrated by the layer integration scheme. The region extraction unit 32 calculates an overlap amount based on the number of convolution layers to be integrated and a kernel size of each convolution layer to be integrated based on the acquired CNN model information and the layer integration application condition.

More specifically, the region extraction unit 32 calculates the overlap amount by the following Formula 1 in a case in which a kernel size of an i-th convolution layer among 0 to N-1 layers to be integrated is kᵢ pixel x kᵢ pixel, wherein kᵢ is an odd number,

$$Overlap amount = 2 \times {\sum }_{i = 0}^{N - 1} \frac{{k}_{i} - 1}{2} . \qquad Formula 1$$

For example, when two layers of a convolution layer A of kernel size 3 pixels×3 pixels and a convolution layer B of kernel size 5 pixels×5 pixels are integrated, the input image is reduced by the number of rows and the number of columns corresponding to one pixel in the convolution layer A and the number of rows and the number of columns corresponding to two pixels in the convolution layer B. That is, 1+2-3 pixels are reduced by the number of rows and the number of columns in total. Therefore, it is necessary to calculate a range in which the number of lines and the number of columns corresponding to three pixels are larger than that of the input image in the first layer among the convolution layers which are integrated by back calculation. Since the same can apply to all the regions, the overlap amount of the adjacent regions is 3 pixels x 2, and the above formula is given.

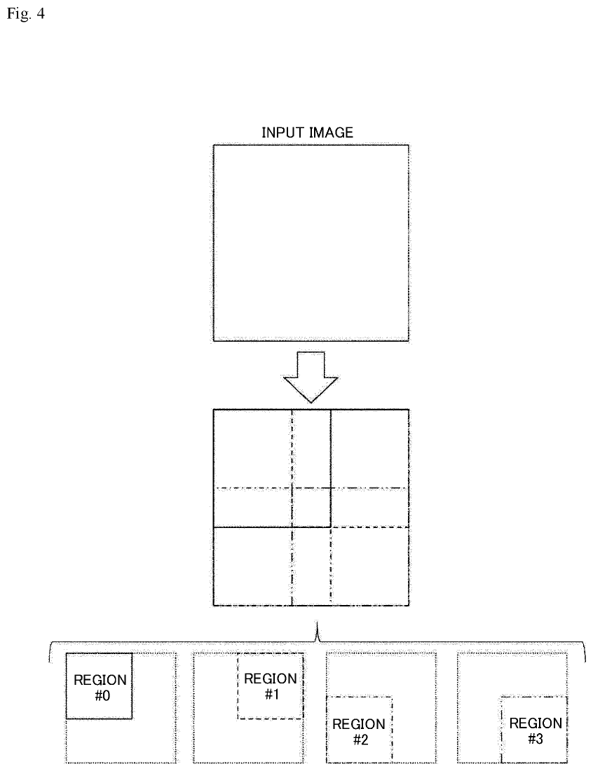

FIG. 4 is a diagram illustrating examples of regions extracted by the region extraction unit 32. As illustrated in the middle part of FIG. 4, the regions extracted from the input image overlap by the overlap amount calculated as described above. In the lower part of FIG. 4, the regions in the input image are separately divided. In the following description, the j-th region extracted from the input image is referred to as “region #j”.

The region extraction unit 32 only determines the range of each region, and it is not necessary to copy data of each region. The processing in the rear stage is performed on each region.

The calculation unit 33 reads the data of the regions extracted by the region extraction unit 32 to the internal memory and performs convolution calculation by a plurality of integrated convolution layers by using the read data of the regions as input data.

The output unit 35 combines and outputs a calculation result by the calculation unit 33 for each of the plurality of regions.

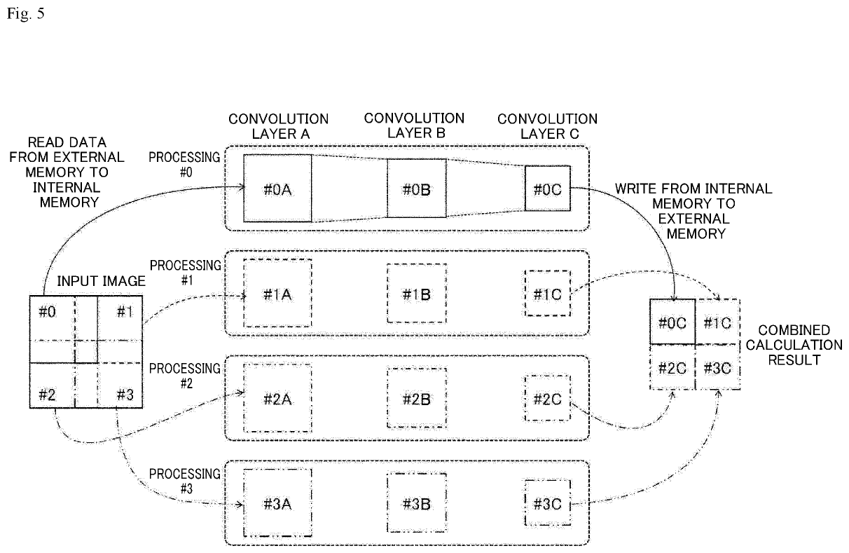

Processing of the calculation unit 33 and the output unit 35 will be described specifically with reference to FIG. 5. In the example of FIG. 5, a case in which the convolutional layers A, B and C are integrated and the input image is divided into regions #0, #1, #2 and #3 is illustrated.

The calculation unit 33 inputs region #0 read to the internal memory to the convolution layer A as processing #0, performs convolution calculation by the convolution layer A, and retains calculation result #0A in the calculation result retention unit 34 provided in the internal memory. Subsequently, the calculation unit 33 inputs calculation result #0A to the convolution layer B, deletes the calculation result from the calculation result retention unit 34, performs the convolution calculation by the convolution layer B, and retains calculation result #0B in the calculation result retention unit 34. Subsequently, the calculation unit 33 inputs calculation result #0B to a convolution layer C, deletes the calculation result from the calculation result retention unit 34, performs the convolution calculation by the convolution layer C, and retains calculation result #0C in the calculation result retention unit 34.

The output unit 35 writes calculation result #0C of the convolution layer C which is a final layer in a predetermined region of the external memory.

When processing #0 is completed on region #0, the calculation unit 33 and the output unit 35 similarly perform processing #1 on region #1, processing #2 on region #2, and processing #3 on region #3 in order. Accordingly, a final calculation result obtained by combining the calculation results of the regions is stored in the external memory.

Next, an operational effect of the convolutional neural network inference processing device 10 according to the first embodiment will be described.

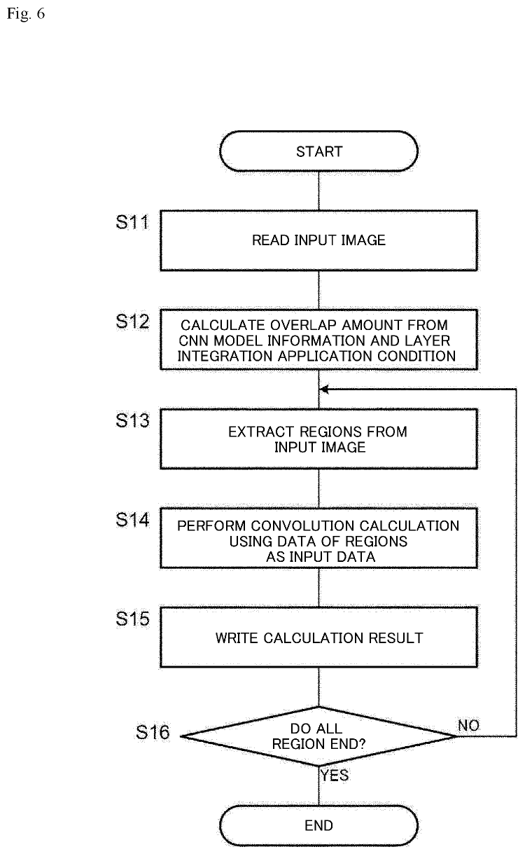

FIG. 6 is a flowchart illustrating a flow of the convolutional neural network inference processing by the convolutional neural network inference processing device 10. The convolutional neural network inference processing is performed by the CPU 11 reading the convolutional neural network inference processing program from the ROM 12 or the storage 14, and loading and executing the convolutional neural network inference processing program into the RAM 13. The convolutional neural network inference processing illustrated in FIG. 6 is processing on one frame of an input moving image, that is, one input image. By repeatedly performing the convolutional neural network inference processing illustrated in FIG. 6 in units of frames, the processing on the entire input moving image is performed.

In step S11, as the input image retention unit 31, the CPU 11 reads and retains an input image corresponding to one frame from the input moving image input to the convolutional neural network inference processing device 10.

Subsequently, in step S12, as the region extraction unit 32, the CPU 11 acquires the CNN model information and the layer integration application condition and calculates an overlap amount based on the number of layers of the convolution layers to be integrated and a kernel size of each of the convolution layers to be integrated.

Subsequently, in step S13, as the region extraction unit 32, the CPU 11 extracts one region in a case in which an input image input to the CNN including a plurality of convolution layers is divided into a plurality of regions. The plurality of regions are regions with the maximum size which is processable as an input image in the related art and regions in which the regions overlap by the calculated overlap amount.

Subsequently, in step S14, as the calculation unit 33, the CPU 11 reads the data of the extracted region to the internal memory, performs the convolution calculation by the plurality of convolution layers to be integrated by using the data of the read region as input data, and retains the calculation result in the calculation result retention unit 34. Subsequently, in step S15, as an output unit 35, the CPU 11 writes the calculation result of a convolution layer which is the final layer of the plurality of integrated convolution layers in a predetermined region of the external memory with regard to the processing target region.

Subsequently, in step S16, as the the region extraction unit 32, the CPU 11 determines whether all the regions are extracted from the input image. When there is an unextracted region, the processing returns to step S13 to extract a subsequent region. When all the regions are extracted, the convolutional neural network inference processing ends.

As described above, in the convolutional neural network inference processing device according to the first embodiment, the overlap amount is calculated based on the number of convolutional layers to be integrated and the kernel size of each of the convolutional layers to be integrated. The convolutional neural network inference processing device extracts each region in a case in which the input image is divided into a region with the maximum size which is processable as the input image in the related art and a plurality of regions in which the regions overlap by the calculated overlap amount. Then, the convolutional neural network inference processing device reads the data in the internal memory in regions of units and performs convolutional calculation by applying the layer integration scheme. Accordingly, the number of calculations increases by the calculation of the overlap portions. However, since it is not necessary to retain the overlap width data of a boundary between the regions, the size of the input image which is processable in the layer integration scheme of the CNN can be expanded without an increase in an internal memory capacity.

### Second Embodiment

In a second embodiment, a case in which a region in the first embodiment is further divided into tiles will be described.

Since a hardware configuration of the convolutional neural network inference processing device 210 according to the second embodiment is similar to the hardware configuration of the convolutional neural network inference processing device 10 according to the first embodiment illustrated in FIG. 2, description thereof will be omitted.

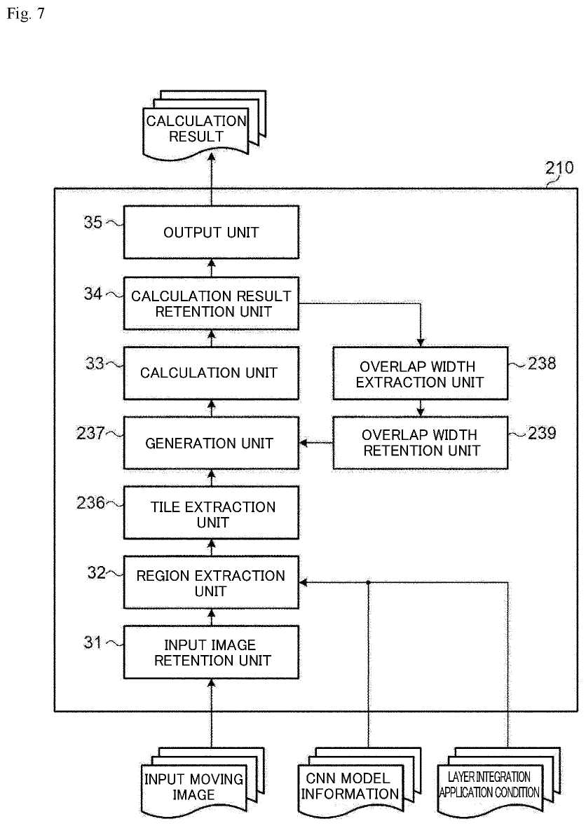

Next, a functional configuration of a convolutional neural network inference processing device 210 will be described. FIG. 7 is a block diagram illustrating an example of a functional configuration of the convolutional neural network inference processing device 210. In the convolutional neural network inference processing device 210, the functional configuration similar to that of the convolutional neural network inference processing device 10 according to the first embodiment are denoted by the same reference numerals, and detailed description thereof will be omitted.

As illustrated in FIG. 7, the convolutional neural network inference processing device 210 includes the input image retention unit 31, the region extraction unit 32, a tile extraction unit 236, a generation unit 237, the calculation unit 33, and the calculation result retention unit 34 as a functional configuration. The convolutional neural network inference processing device 210 includes an overlap width extraction unit 238, an overlap width retention unit 239, and an output unit 35. Each functional configuration is realized by the CPU 11 reading the convolutional neural network inference processing program stored in the ROM 12 or the storage 14, and loading and executing the convolutional neural network inference processing program into the RAM 13.

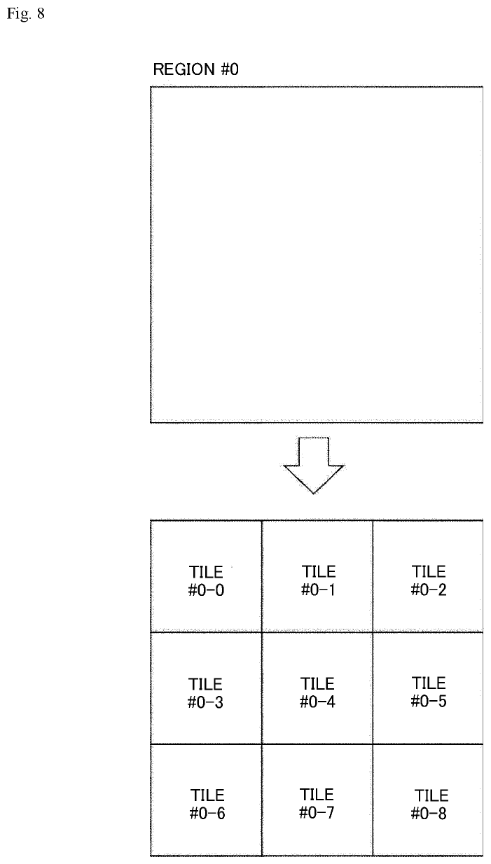

The tile extraction unit 236 extracts each tile from the plurality of tiles obtained by dividing the region extracted by the region extraction unit 32 in a grid form. FIG. 8 illustrates an example in which region #0 is divided into nine tiles #0-0 to #0-8. The tile extraction unit 236 only determines a range of each tile, and it is not necessary to copy data of each tile. The processing in the rear stage is performed on each tile.

The generation unit 237 reads the data of the tile extracted by the tile extraction unit 236 to an internal memory, combines the read data of the tile and the overlap width data retained in the overlap width retention unit 239, and generates input data for the calculation unit 33.

The overlap width extraction unit 238 extracts overlap width data required for processing of subsequent tiles from the calculation result of each of the convolution layers which are retained in the calculation result retention unit 34 to be integrated.

The overlap width retention unit 239 retains the overlap width data extracted by the overlap width extraction unit 238.

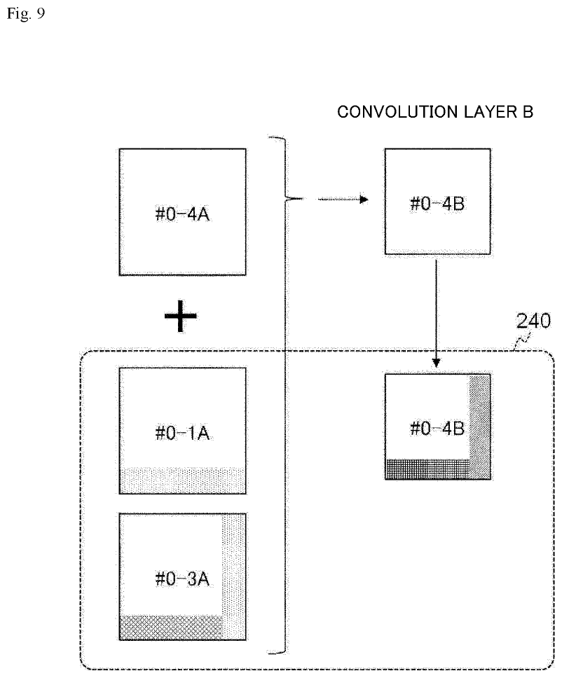

Processing of the generating unit 237, the calculation unit 33, and the overlap width extraction unit 238 will be described specifically with reference to FIG. 9. In the example illustrated in FIG. 9, a case in which tile #0-4 among the tiles extracted from region #0 is a processing target will be described focusing on the convolution layer B in an example similar to that illustrated in FIG. 5.

The generation unit 237 generates input data to the convolution layer B by combining calculation result #0-4A of the convolution layer A to tile #0-4 and the overlap width data retained in the overlap width retention unit 239. The overlap width data is a portion (halftone dot portion in FIG. 9) adjacent to operation result #0-4A of each of operation results #0-1A and #0-3A of the convolution layer A for each of tiles #0-1 and #0-3 adjacent to tile #0-4. In FIG. 9, the overlap width data in the horizontal direction (an oblique lattice portion in FIG. 9) of operation result #0-3 is overlap width data used when the processing target tile is tile #0-6.

The calculation unit 33 performs convolution processing by a convolution layer B to the input data generated by the generation unit 237 and retains calculation result #0-4B in the calculation result retention unit 34. The overlap width extraction unit 238 extracts a portion in contact with the adjacent tile in calculation results #0-4B retained by the calculation result retention unit 34 as overlap width data for the subsequent processing target tile, and retains the overlap width data in the overlap width retention unit 239. The overlap width data in the vertical direction (an oblique portion in FIG. 9) of calculation results #0-4B is overlap width data used when a processing target tile is tile #0-5. The overlap width data in the horizontal direction (a lattice portion in FIG. 9) of calculation results #0-4B is overlap width data used when a processing target tile is tile #0-7.

Next, an operational effect of the convolutional neural network inference processing device 210 according to the second embodiment will be described.

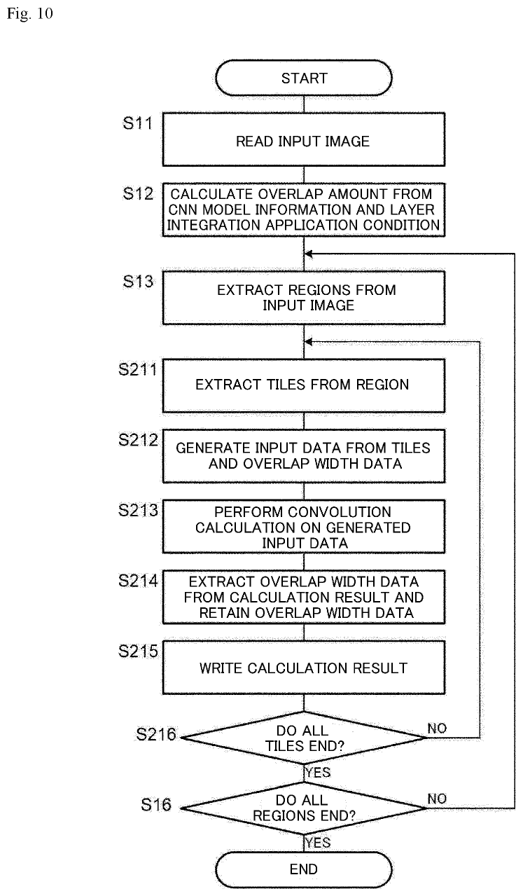

FIG. 10 is a flowchart showing a flow of the convolutional neural network inference processing by the convolutional neural network inference processing device 210. The convolutional neural network inference processing is performed by the CPU 11 reading the convolutional neural network inference processing program from the ROM 12 or the storage 14, and loading and executing the convolutional neural network inference processing program into the RAM 13. In the convolutional neural network inference processing according to the second embodiment, the processing similar to the convolutional neural network inference processing (FIG. 6) according to the first embodiment is denoted by the same reference numerals and detailed description thereof will be omitted.

When a region is extracted from the input image through steps S11 to S13, as a tile extraction unit 236, the CPU 11 extracts one tile from a plurality of tiles obtained by dividing the extracted region in the grid form in subsequent step S211.

Subsequently, in step S212, as the generation unit 237, the CPU 11 reads the data of the extracted tile to the internal memory, combines the data of the read tile and the overlap width data retained in the overlap width retention unit 239 to generate input data.

Subsequently, in step S213, as a calculation unit 33, the CPU 11 inputs the generated input data generated to the first layer among the plurality of integrated convolution layers, performs the convolution calculation, and retains a calculation result in the calculation result retention unit 34. Subsequently, in step S214, as the overlap width extraction unit 238, the CPU 11 extracts the overlap width data required for the processing of the subsequent tiles among the calculation results retained in the calculation result retention unit 34, and retains the overlap width data in the overlap width retention unit 239. The processing of steps S213 and S214 is also sequentially performed for the subsequent layers of the plurality of integrated convolution layers.

Subsequently, in step S215, as the output unit 35, the CPU 11 writes a calculation result of the convolution layer which is the final layer of the plurality of integrated convolution layers with regard to the tile extracted in step S211 in a predetermined region of the external memory.

Subsequently, in step S216, as the tile extraction unit 236, the CPU 11 determines whether all the tiles are extracted from the region extracted in step S13. When there is the unextracted tile, the processing returns to step S211 to extract the subsequent tile. When all the tiles are extracted, the processing proceeds to step S16. When it is determined in step S16 that all the regions are extracted from the input image, the convolutional neural network inference processing ends.

As described above, in the convolutional neural network inference processing device according to the second embodiment, the tiles obtained by further dividing the region are extracted from the region extracted from the input image as in the first embodiment, and calculation processing through the layer integration is performed for each tile. In the convolution processing of each tile, the overlap width data required for the convolution processing is extracted from the processed tile and the calculation result, is retained, and is used for the calculation processing of the subsequent tile. Accordingly, as in the first embodiment, the size of the input image which is processable in the layer integration scheme of the CNN can be expanded without an increase in the internal memory capacity.

In the first embodiment, since the overlap width retention unit is unnecessary, a memory capacity can be reduced as compared with the second embodiment.

In each of the above embodiments, the convolutional neural network inference processing performed by the CPU reading software (program) may be performed by any of various processors other than the CPU. Examples of processors in this case include a programmable logic device (PLD) such as a field-programmable gate array (FPGA) of which a circuit configuration can be changed after production and a dedicated electrical circuit that is a processor with a circuit configuration such as an application specific integrated circuit (ASIC) designed to execute specific processing. The convolutional neural network inference processing may be executed by one of these various types of processors or a combination of two or more processors of the same type or different types (for example, a plurality of FPGAs and a combination of a CPU and an FPGA, or the like). A hardware structure of such various processors is an electrical circuit in which circuit elements such as semiconductor elements are combined more specifically.

In each of the above embodiments, the mode in which the convolutional neural network inference processing program is stored (installed) in advance in the ROM 12 or the storage 14 has been described, but the present disclosure is not limited thereto. The program may also be provided in a form in which the program is stored in a non-transitory storage medium such as a compact disk read only memory (CD-ROM), a digital versatile disk read only memory (DVD-ROM), or a Universal Serial Bus (USB) memory. The program may be downloaded from an external device via a network.

The following supplements are further disclosed in relation to the above embodiments.

### (Supplement 1)

A convolutional neural network inference processing device including:
a memory; and
at least one processor connected to the memory,
wherein
the processor is configured to:
   extracts each region in a case in which an input image input to a convolutional neural network including a plurality of convolutional layers is divided into a region of a maximum size which is processable as the input image and a plurality of regions obtained by overlapping regions with an overlap amount corresponding to a reduction in the input image by the convolutional layers;
   performs convolution calculation by the plurality of convolution layers that are integrated using data of the extracted region as input data; and
   combines and outputs results of the calculation on the plurality of regions.

### (Supplement 2)

A non-transitory recording medium storing a program that can be executed by a computer to execute convolutional neural network inference processing,
wherein the convolutional neural network inference processing includes
   extracting each region in a case in which an input image input to a convolutional neural network including a plurality of convolutional layers is divided into a region of a maximum size which is processable as the input image and a plurality of regions obtained by overlapping regions with an overlap amount corresponding to a reduction in the input image by the convolutional layers;
   performing convolution calculation by the plurality of convolution layers that are integrated using data of the extracted region as input data; and
      combining and outputting results of the calculation on the plurality of regions.

### REFERENCE SIGNS LIST

10, 210 Convolutional neural network inference processing device
11 CPU
12 ROM
13 RAM
14 Storage
15 Input unit
16 Display unit
17 Communication I/F
19 Bus
31 Input image retention unit
32 Region extraction unit
33 Calculation unit
34 Calculation result retention unit
35 Output unit
236 Tile extraction unit
237 Generation unit
238 Overlap width extraction unit
239 Overlap width retention unit

1. A convolutional neural network inference processing device, comprising:
a memory; and
at least one processor coupled to the memory,
wherein the at least one processor is configured to:
extract each region in a case in which an input image input to a convolutional neural network including a plurality of convolutional layers is divided into a region of a maximum size, which is processable as the input image, and a plurality of regions obtained by overlapping regions with an overlap amount corresponding to a reduction in the input image by the convolutional layers;
perform convolution calculation by the plurality of convolution layers that are integrated using data of the region extracted as input data; and
combine and output results of the calculation performed by on each of the plurality of regions.

2. The convolutional neural network inference processing device according to claim 1, wherein the at least one processor is further configured to:
calculate the overlap amount based on a number of layers of the convolutional layers to be integrated and a kernel size of each of the convolutional layers to be integrated.

3. The neural network inference processing device according to claim 2, wherein the at least one processor is further configured to:
calculate the overlap amount by the following Formula 1 in a case in which a kernel size of an i-th convolution layer among 0 to N−1 layers to be integrated is kᵢ pixel x kᵢ pixel, wherein kᵢ is an odd number,
$$Overlap amount = 2 \times {\sum }_{i = 0}^{N - 1} \frac{{k}_{i} - 1}{2} . \qquad Formula 1$$

4. The convolutional neural network inference processing device according to claim 1, wherein the at least one processor is further configured to:
extract each tile from a plurality of tiles obtained by dividing the region in a grid form, and
perform convolution calculation by the plurality of integrated convolution layers by using, as the input data, data obtained by combining data of a processing target tile that is extracted and overlap width data which is a portion of a tile adjacent to the processing target tile.

5. The convolutional neural network inference processing device according to claim 4, wherein the at least one processor is further configured to:
extract data of a portion in contact with an adjacent tile as the overlap width data of subsequent processing target tiles in a calculation result of the processing target tile.

6. The convolutional neural network inference processing device according to claim 1,
wherein the input image is stored in an external memory, and
wherein the at least one processor is further configured to:
read the region extracted from the external memory to an internal memory, retain the calculation result in each of the plurality of convolution layers to be integrated in the internal memory, and delete a calculation result input to a subsequent convolution layer from the internal memory, and
sequentially combine the calculation results of the plurality of regions by sequentially performing processing for storing a calculation result of a final layer among the plurality of convolution layers in the external memory for each of the regions.

7. A convolutional neural network inference processing method, comprising, by a computer:
extracting each region in a case in which an input image input to a convolutional neural network including a plurality of convolutional layers is divided into a region of a maximum size, which is processable as the input image, and a plurality of regions obtained by overlapping regions with an overlap amount corresponding to a reduction in the input image by the convolutional layers;
performing convolution calculation by the plurality of convolution layers that are integrated using data of the region extracted by the region extraction unit as input data; and
combining and outputting results of the calculation performed on each of the plurality of regions.

8. A non-transitory computer readable medium storing a program executable by a computer to perform a process for convolutional neural network inference processing, the process comprising:
extracting each region in a case in which an input image input to a convolutional neural network including a plurality of convolutional layers is divided into a region of a maximum size, which is processable as the input image, and a plurality of regions obtained by overlapping regions with an overlap amount corresponding to a reduction in the input image by the convolutional layers;
performing convolution calculation by the plurality of convolution layers that are integrated using data of the region extracted as input data; and
combining and outputting results of the calculation performed on each of the plurality of regions.
